(19) United States
(12) Patent Application Publication
(10) Pub. No.: US 2025/0163247 A1
(43) Pub. Date: May 22, 2025

(54) RESIN COMPOSITION, APPLICATION THEREOF, AND MOLDING METHOD THEREFOR

(71) Applicant: Osaka Gas Chemicals Co., Ltd., Osaka-shi, Osaka (JP)

(72) Inventors: Masayuki HIROTA, Osaka (JP); Asami MAEDA, Osaka (JP)

(73) Assignee: Osaka Gas Chemicals Co., Ltd., Osaka-shi, Osaka (JP)

(21) Appl. No.: 18/841,492

(22) PCT Filed: Feb. 10, 2023
(86) PCT No.: PCT/JP2023/004472

§ 371 Date: Aug. 26, 2024

(30) Foreign Application Priority Data
Mar. 2, 2022 (JP) 2022-031858

(51) Int. Cl. C08L 1/12; B29C 45/00; B29K 1/00; C08K 5/1545

(52) U.S. Cl. CPC C08L 1/12; B29C 45/0001; C08K 5/1545; B29K 2001/12; B29K 2995/0012; B29K 2995/0026; B29K 2995/0082; B29K 2995/0089; C08L 2203/30

(57) ABSTRACT

Prepared is a melt-molding resin composition containing a thermoplastic resin and a sugar ester. The thermoplastic resin is a cellulose diacetate (A). The sugar ester contains a sugar alkanoic acid ester (B) which is an esterified product of at least one member selected from the group consisting of a monosaccharide, an oligosaccharide, and a sugar alcohol with a C₂₋₆alkanoic acid. The sugar alkanoic acid ester (B) may be sucrose octaacetate. The ratio of the sugar alkanoic acid ester (B) relative to 100 parts by mass of the cellulose diacetate may be 10 to 65 parts by mass. The resin composition may be an injection-molding resin composition. The resin composition has excellent melt moldability, transparency, and mechanical characteristics.

### TECHNICAL FIELD

The present invention relates to a resin composition containing a cellulose diacetate, and an application and a molding method of the same.

### BACKGROUND ART

A cellulose acetate is a resin having excellent transparency, heat resistance, and mechanical characteristics, while the cellulose acetate has a low moldability (or formability). The cellulose acetate is thus often molded by a solution casting method which includes dissolving the cellulose acetate in a solvent and casting the solution. For example, Japanese Patent Application Laid-Open Publication No. 2016-164669 (JP 2016-164669 A, Patent Document 1) discloses a cellulose acetate film produced by a solution casting method using a polyester oligomer and a sugar ester compound as additives.

The solution casting method, which includes dissolving the cellulose acetate in a solvent, limits the shape of the resulting molded article. A known molding method also includes a melt-molding method. However, since it is difficult to melt-mold the cellulose acetate resin alone, a plasticizer is used for the melt-molding.

Japanese Patent Application Laid-Open Publication No. 2003-526694 (JP 2003-526694 A, Patent Document 2) discloses a process for blending a cellulose ester with a functional additive, the process comprising mixing the functional additive such as sucrose acetate isobutyrate with the cellulose ester and an acid and contacting the mixture with an aqueous precipitating agent such as water, whereby a blend comprising the cellulose ester and the functional additive coprecipitates.

Japanese Patent Application Laid-Open Publication No. 2021-109942 (JP 2021-109942 A, Patent Document 3) discloses a composite material produced by kneading a cellulose acetate containing a cellulose nanofiber, and a plasticizer such as ethyl acetate, butyl lactate, dioctyl phthalate, triethyl citrate, tributyl citrate, and trioctyl phosphate with an extruder.

WO 2008/062610 (Patent Document 4) discloses a method for producing a cellulose ester film, the method comprising melt-casting a composition which contains a cellulose ester such as a cellulose acetate propionate and a cellulose acetate butyrate, an acrylic polymer, and a sugar ester compound such as glucose pentaacetate, sucrose octaacetate, sucrose octapropionate, sucrose octaisobutyrate, sucrose octabenzoate, and maltose octaacetate.

WO 2009/011228 (Patent Document 5) discloses a method for producing a cellulose ester film, the method comprising melt-casting a composition which contains a cellulose ester such as a cellulose acetate propionate, a partially esterified sugar such as sucrose hexaacetate, sucrose hexapropionate, sucrose heptapropionate, sucrose hexabenzoate, and sucrose heptabenzoate, and a completely esterified sugar such as glucose pentaacetate, glucose pentabutyrate, sucrose octaacetate, sucrose octapropionate, and sucrose octabenzoate.

### CITATION LIST

### Patent Literature

Patent Document 1: JP 2016-164669 A
Patent Document 2: JP 2003-526694 A
Patent Document 3: JP 2021-109942 A
Patent Document 4: WO 2008/062610
Patent Document 5: WO 2009/011228

### SUMMARY OF INVENTION

### Technical Problem

However, while the compositions of Patent Documents 2 to 5 yield molded articles with an excellent transparency, the compositions have a low melt flowability. Since the compositions of Patent Documents 2 to 5 have a low flowability, in particular, a low melt flowability, the compositions have a low melt moldability (or melt formability). Thus, it is difficult to use the compositions in molding that uses a high melt flowability, such as injection molding. Further, according to conventional arts, a cellulose acetate softened by addition of a plasticizer has low mechanical characteristics. Thus, there is a trade-off between the flowability and the mechanical characteristics, and it is difficult to achieve the both characteristics.

It is therefore an object of the present invention to provide a resin composition having excellent melt moldability (or melt formability), transparency, and mechanical characteristics, and an application (or use) and a molding (or forming) method of the resin composition.

### Solution to Problem

The inventors of the present invention made intensive studies to achieve the above object and finally found that a combination of a thermoplastic resin containing a cellulose diacetate (A) [in particular, a thermoplastic resin consisting of a cellulose diacetate (A)] and a sugar ester containing a specific (or specified) sugar alkanoic acid esterified product (B) provides a resin composition having excellent melt moldability, transparency, and mechanical characteristics. The present invention was accomplished based on the above findings.

That is, a resin composition as an aspect [1] of the present invention is a melt-molding resin composition (or a melt-moldable resin composition or a resin composition for melt-molding) containing a thermoplastic resin and a sugar ester, the thermoplastic resin is a cellulose diacetate (A), and the sugar ester contains a sugar alkanoic acid ester (B) which is an esterified product of at least one member selected from the group consisting of a monosaccharide, an oligosaccharide, and a sugar alcohol with a C₂₋₆alkanoic acid.

An aspect [2] of the present invention is an aspect in which the sugar alkanoic acid ester (B) in the aspect [1] is an ester of a monosaccharide or a disaccharide with a C₂₋₄alkanoic acid.

An aspect [3] of the present invention is an aspect in which the sugar alkanoic acid ester (B) in the aspect [1] or [2] is a completely (or fully) esterified product of a disaccharide with a C₂₋₃alkanoic acid.

An aspect [4] of the present invention is an aspect in which the sugar alkanoic acid ester (B) in any one of the aspects [1] to [3] is sucrose octaacetate.

An aspect [5] of the present invention is an aspect in which a proportion of the sucrose octaacetate in the aspect [4] is not less than 90% by mass in the sugar ester.

An aspect [6] of the present invention is an

aspect in which a ratio of the sugar alkanoic acid ester (B) in any one of the aspects [1] to [5] is 10 to 65 parts by mass relative to 100 parts by mass of the cellulose diacetate (A).

An aspect [7] of the present invention is an aspect in which the resin composition of any one of the aspects [1] to [6] is an injection-molding resin composition (or a resin composition for injection molding).

An aspect [8] of the present invention is an

aspect in which the resin composition of any one of the aspects [1] to [7] is free from at least one member selected from the group consisting of a cellulose triacetate, a (meth)acrylic resin, and a polyester oligomer.

The present invention also includes an aspect [9] which includes a molded article (or a molded product or a molded body) containing (or formed with) the resin composition of any one of the aspects [1] to [8].

An aspect of the present invention is an aspect in which the molded article of the aspect [9] is a part or material or member selected from an automotive part, an electrical/electronic part, a building material or member, a civil engineering material or member, an agricultural material or member, a packaging material or member, a daily life material or member, and an optical member.

The present invention also includes an aspect [11] which includes a method for producing a molded article, the method including melt-molding the resin composition of any one of the aspects [1] to [8].

An aspect [12] of the present invention is an aspect in which the resin composition is injection-molded to produce the molded article in the method of the aspect [11].

The present invention also includes an aspect [13] which includes a strength improver which improves a strength of a cellulose diacetate (A), and the strength improver contains a sugar alkanoic acid ester (B) which is an esterified product of at least one member selected from the group consisting of a monosaccharide, an oligosaccharide, and a sugar alcohol with a C₂₋₆alkanoic acid.

The present invention also includes an aspect [14] which includes a flow improver which improves a melt flowability (or a melt fluidity) of a cellulose diacetate (A), and the flow improver contains a sugar alkanoic acid ester (B) which is an esterified product of at least one member selected from the group consisting of a monosaccharide, an oligosaccharide, and a sugar alcohol with a C₂₋₆alkanoic acid.

The present invention also includes an aspect [15] which includes a method for improving a melt flowability and/or a strength of a cellulose diacetate (A), and the method includes mixing a sugar alkanoic acid ester (B) with the cellulose diacetate (A), in which the sugar alkanoic acid ester (B) is an esterified product of at least one member selected from the group consisting of a monosaccharide, an oligosaccharide, and a sugar alcohol with a C₂₋₆alkanoic acid.

In the description and the claims of this [15] application, the number of carbon atoms in a substituent may be represented as C₁, C₆, C₁₀, or others. For example, “C₁alkyl group” means an alkyl group having one carbon atom, and “C₆₋₁₀aryl group” means an aryl group having 6 to 10 carbon atoms.

### Advantageous Effects of Invention

According to the present invention, the combination of the thermoplastic resin containing the cellulose diacetate (A) [in particular, the thermoplastic resin consisting of the cellulose diacetate (A)] and the sugar ester containing the specific sugar alkanoic acid ester (B) improves the melt moldability, the transparency, and the mechanical characteristics of the resin composition. In particular, the resin composition containing the specific sugar alkanoic acid ester (B) at a predetermined ratio has improved transparency, flexural strength, flexural modulus, and impact strength while maintaining the melt moldability enough for injection molding. Moreover, use of the specific sugar alkanoic acid ester (B) as the sugar ester achieves a high biodegradability in the combination with the cellulose diacetate (A).

### DESCRIPTION OF EMBODIMENTS

### Thermoplastic Resin

The resin composition of the present invention contains a thermoplastic resin and is to be subjected to melt-molding. Further, the thermoplastic resin contains a cellulose diacetate (or a cellulose diacetate resin) (A) and thus has excellent transparency and mechanical characteristics.

The cellulose diacetate (A) may include a widely used cellulose diacetate. The cellulose diacetate (A) has a degree of acetylation of 52 to 59%. The degree of acetylation is preferably 53 to 58%, further preferably 54 to 56%, and more preferably 54.5 to 55.5%. The cellulose diacetate (A) has an average degree of substitution (a total degree of acetyl substitution) of 2.2 to 2.7. The average degree of substitution is preferably 2.3 to 2.6 and further preferably 2.3 to 2.5. In a case where the cellulose diacetate (A) has an excessively low degree of acetyl substitution, the cellulose diacetate (A) has a stronger intermolecular hydrogen bond, which may result in lowering the moldability (or formability) of the resin composition. In contrast, in a case where the cellulose diacetate (A) has an excessively high degree of acetyl substitution, the cellulose diacetate (A) has a higher melting point. This may increase the molding temperature of the resin composition, causing thermal decomposition in molding of the resin composition.

In the description and the claims of this application, the degree of acetylation and the average degree of substitution of the cellulose diacetate (A) can be measured in accordance with ASTM-D-817-91 (Test method for cellulose acetate, etc.).

The cellulose diacetate (A) has a 6% viscosity (25° C.) of, for example, 30 to 200 mPa·s, preferably 40 to 150 mPa·s, further preferably 50 to 100 mPa·s, and more preferably 60 to 80 mPa·s. In a case where the 6% viscosity is excessively low, the resulting molded article (or product) may have low mechanical characteristics. In contrast, in a case where the 6% viscosity is excessively high, the resin composition may have a low moldability.

In the description and the claims of this application, the 6% viscosity of the cellulose diacetate (A) can be determined according to a conventional method, for example, a method which includes dissolving a cellulose diacetate in a 95% acetone aqueous solution at a concentration of 6% (mass/volume %) and measuring a flow time of the resulting solution using an Ostwald viscometer.

The thermoplastic resin may further contain another thermoplastic resin in addition to the cellulose diacetate (A).

Examples of another thermoplastic resin may include a polyolefinic resin, a styrenic resin, a (meth)acrylic resin, a vinyl chloride-series resin, a poly(vinyl alcohol)-series resin, a polyacetal-series resin, a polyester-series resin, a polycarbonate-series resin, a polyamide-series resin, a polyimide-series resin, a polyurethane-series resin, a polysulfone-series resin, a poly(phenylene ether)-series resin, a poly(phenylene sulfide)-series resin, a fluororesin, and a cellulose derivative other than the cellulose diacetate (A), Such another thermoplastic resin may be used alone or in combination of two or more.

As such another thermoplastic resin, the cellulose derivative is preferred in view of an excellent compatibility with the cellulose diacetate (A).

Examples of the cellulose derivative may include an alkylcellulose such as a methylcellulose, an ethylcellulose, an ethylmethylcellulose, a propylcellulose, an isopropylcellulose, and a butylcellulose; an aralkylcellulose such as a benzylcellulose; a hydroxyalkylcellulose such as a hydroxyethylcellulose and a hydroxypropylcellulose; a carboxyalkylcellulose such as a carboxymethylcellulose; a cellulose C₃₋₄acylate such as a cellulose propionate and a cellulose butyrate; a cellulose acetate C₃₋₄acylate such as a cellulose acetate propionate and a cellulose acetate butyrate; and a cellulose inorganic acid ester such as a nitrocellulose, a cellulose sulfate, and a cellulose phosphate. Among them, the cellulose acylate such as a cellulose C₂₋₄acylate and a cellulose acetate C₃₋₄acylate is preferred in view of an excellent compatibility with the cellulose diacetate,

The ratio of another thermoplastic resin relative to 100 parts by mass of the cellulose diacetate (A) may be not more than 100 parts by mass (such as 0.1 to 100 parts by mass) and is preferably not more than 50 parts by mass (such as 1 to 50 parts by mass), further preferably not more than 10 parts by mass, more preferably not more than 5 parts by mass, and most preferably not more than 1 part by mass. In a case where the ratio of another thermoplastic resin is excessively high, the moldability or the mechanical characteristics may be lowered due to a reduced effect of adding the after-mentioned sugar alkanoic acid ester (B).

The thermoplastic resin preferably contains the cellulose diacetate (A) as a main component. The proportion of the cellulose diacetate (A) in the thermoplastic resin may be not less than 50% by mass and is preferably not less than 80% by mass, further preferably not less than 90% by mass, more preferably not less than 95% by mass, and most preferably not less than 99% by mass. The thermoplastic resin may substantially consist of the cellulose diacetate (A) alone and particularly preferably consists of the cellulose diacetate (A) alone.

Since the thermoplastic resin preferably contains the cellulose diacetate (A) as a main component, the thermoplastic resin is preferably substantially free from a cellulose acetate other than the cellulose diacetate and is particularly preferably free from a cellulose acetate other than the cellulose diacetate.

The thermoplastic resin is preferably substantially free from a (meth)acrylic resin and is particularly preferably free from a (meth)acrylic resin.

### Sugar Ester

The resin composition of the present invention contains a sugar ester in addition to the thermoplastic resin containing the cellulose diacetate (A). In the description and the claims of this application, the sugar ester is a compound also referred to as an esterified sugar (or an esterified saccharide) or a sugar ester compound (or a saccharide ester compound) and means an esterified product of at least one member (a low molecular weight sugar) selected from the group consisting of a monosaccharide, an oligosaccharide, and a sugar alcohol with a carboxylic acid.

The sugar ester contains a sugar alkanoic acid ester (B) which is an esterified product of at least one member selected from the group consisting of a monosaccharide, an oligosaccharide, and a sugar alcohol with a C₂₋₆alkanoic acid (an aliphatic monocarboxylic acid), and thus can improve the melt moldability of the resin composition. For a conventional plasticizer, it is difficult to highly improve a flowability (or a fluidity) of the cellulose diacetate (A), for example, it is difficult to achieve a melt flowability of the cellulose diacetate (A) enough for injection molding. In contrast, according to the present invention, use of the sugar alkanoic acid ester (B) achieves a melt flowability enough for injection molding. Further, the sugar alkanoic acid ester (B) can improve not only the melt flowability but also the mechanical characteristics, which have a trade-off relationship with the flowability for the blend of the conventional plasticizer, in particular, a flexural strength, a flexural modulus, and an impact strength (particularly, a strength). Furthermore, a combination of the cellulose diacetate (A) and the sugar alkanoic acid ester (B) has a high melt flowability and an excellent kneadability, and thus the combination can maintain the transparency of the cellulose diacetate (A) and can improve the transparency of the resin composition and the molded article.

Examples of the monosaccharide may include a pentose such as arabinose, xylose, ribose, and deoxyribose; and a hexose such as glucose, fructose, galactose, mannose, sorbose, fucose, rhamnose, galacturonic acid, glucuronic acid, mannuronic acid, and glucosamine.

The oligosaccharide can be roughly divided into a disaccharide and a tri- or higher oligosaccharide. Examples of the disaccharide may include a heterodisaccharide such as sucrose and Palatinose; and a homodisaccharide such as cellobiose, lactose, isomerized lactose (lactulose); maltose, isomaltose, gentiobiose, kojibiose, laminaribiose, melibiose, sophorose, and trehalose. The tri- or higher oligosaccharide may include, for example, melezitose, raffinose, stachyose, and cyclodextrin.

Examples of the sugar alcohol may include xylitol, erythritol, sorbitol, mannitol, hydrogenated maltose starch syrup (maltitol), hydrogenated starch hydrolysate, hydrogenated Palatinose, hydrogenated lactose (lactitol), and pentaerythritol.

These low molecular weight sugars may be used alone or in combination of two or more. Among these low molecular weight sugars, the monosaccharide or the disaccharide is preferred, the disaccharide is further preferred, the heterodisaccharide is more preferred, and sucrose is most preferred.

Examples of the C₂₋₆alkanoic acid may include an aliphatic monocarboxylic acid such as acetic acid, propionic acid, butyric acid, isobutyric acid, valeric acid, and caproic acid. These C₂₋₆alkanoic acids may be used alone or in combination of two or more. Among these C₂₋₆alkanoic acids, a C₂₋₄alkanoic acid is preferred, a C₂₋₃alkanoic acid is further preferred, and acetic acid is most preferred.

The sugar alkanoic acid ester (B) may be a partially esterified product in which part of hydroxy groups in the low molecular weight sugar is esterified. The sugar alkanoic acid ester (B) preferably has a higher degree of esterification and is particularly preferably a completely (or fully) esterified product in which all hydroxy groups in the low molecular weight sugar are esterified.

As the sugar alkanoic acid ester (B), preferred is an ester of the monosaccharide or the disaccharide with the C₂₋₆alkanoic acid, in particular, an ester of the disaccharide with the C₂₋₆alkanoic acid.

Examples of the ester of the monosaccharide with the C₂₋₆alkanoic acid may include glucose acetate, glucose propionate, glucose butyrate, glucose isobutyrate, glucose acetate propionate, and glucose acetate isobutyrate.

The ester of the disaccharide with the C₂₋₆alkanoic acid may include, for example, sucrose acetate, sucrose propionate, sucrose butyrate, sucrose isobutyrate, sucrose acetate propionate, and sucrose acetate isobutyrate.

Among them, as the sugar alkanoic acid ester (B), preferred is an ester of the disaccharide with the C₂₋₄alkanoic acid, for example, an esterified product of the heterodisaccharide with the C₂₋₄alkanoic acid, such as sucrose acetate, sucrose propionate, and sucrose acetate isobutyrate, and further preferred is a sucrose tetra- to octaC₂₋₄alkanoate, such as sucrose tetraacetate, sucrose hexaacetate, and sucrose octaacetate. In particular, a completely esterified product of sucrose with the C₂₋₃alkanoic acid (an octaC₂₋₃alkanoate) is more preferred, and sucrose octaacetate is most preferred. The sugar alkanoic acid ester (B) such as sucrose octaacetate has a biodegradability, and thus a combination of the sugar alkanoic acid ester (B) with the cellulose diacetate (A) can achieve an environmentally friendly material.

The sugar ester may further contain another sugar ester in addition to the sugar alkanoic acid ester (B).

Examples of another sugar ester may include an esterified product of at least one member selected from the group consisting of a monosaccharide, an oligosaccharide, and a sugar alcohol with at least one member selected from the group consisting of an aliphatic carboxylic acid other than the C₂₋₆alkanoic acid, an alicyclic carboxylic acid, and an aromatic carboxylic acid. The monosaccharide, the oligosaccharide, and the sugar alcohol may include, for example, the low molecular weight sugar exemplified as the low molecular sugar constituting the sugar alkanoic acid ester (B). As the aliphatic carboxylic acid, there may be mentioned, for example, a C₁₂₋₂₄alkanoic acid such as stearic acid, oleic acid, and palmitic acid. Examples of the alicyclic carboxylic acid may include cyclohexanecarboxylic acid, tetrahydrobenzoic acid, and naphthenic acid. As the aromatic carboxylic acid, there may be mentioned benzoic acid and methylbenzoic acid.

Such another sugar ester may be used alone or in combination of two or more. Among them, widely used is, for example, a sucrose fatty acid ester (an ester of sucrose with a C₁₂₋₂₄alkanoic acid such as stearic acid, oleic acid, and palmitic acid) and a sucrose aromatic carboxylic acid ester such as sucrose benzoate.

The ratio of another sugar ester relative to 100 parts by mass of the sugar alkanoic acid ester (B) may be not more than 100 parts by mass (such as 0.1 to 100 parts by mass) and is preferably not more than 50 parts by mass (such as 1 to 50 parts by mass), further preferably not more than 10 parts by mass, more preferably not more than 5 parts by mass, and most preferably not more than 1 part by mass. In a case where the ratio of another sugar ester is excessively high, the moldability or the mechanical characteristics may be lowered due to a reduced effect of adding the sugar alkanoic acid ester (B).

It is preferred that the sugar ester contain the sugar alkanoic acid ester (B) as a main component. The proportion of the sugar alkanoic acid ester (B) in the sugar ester may be not less than 50% by mass and is preferably not less than 80% by mass, further preferably not less than 90% by mass, more preferably not less than 95% by mass, and most preferably not less than 998 by mass. The sugar ester may substantially consist of the sugar alkanoic acid ester (B) alone and particularly preferably consists of the sugar alkanoic acid ester (B) alone.

It is particularly preferred that the sugar ester contain sucrose octaacetate as a main component. The proportion of sucrose octaacetate in the sugar ester may be not less than 50% by mass and is preferably not less than 80% by mass, further preferably not less than 90% by mass, more preferably not less than 95% by mass, and most preferably not less than 99% by mass. The sugar ester may substantially consist of sucrose octaacetate alone and particularly preferably consists of sucrose octaacetate alone.

Since it is preferred that the sugar ester contain the sugar alkanoic acid ester (B) as a main component, the sugar ester is preferably substantially free from other sugar esters and is particularly preferably free from other sugar esters.

The ratio of the sugar ester [in particular, the sugar alkanoic acid ester (B) such as sucrose octaacetate] relative to 100 parts by mass of the thermoplastic resin is, for example, 1 to 80 parts by mass, preferably 5 to 60 parts by mass, and further preferably 10 to 50 parts by mass. In a case where the ratio of the sugar ester is excessively low, the moldability may be lowered. In contrast, the ratio is excessively high, the transparency and the mechanical characteristics may be lowered.

The ratio of the sugar alkanoic acid ester (B) (in particular, sucrose octaacetate) relative to 100 parts by mass of the cellulose diacetate (A) may be selected from a range of about 5 to 70 parts by mass and is, for example, 10 to 65 parts by mass, preferably 15 to 60 parts by mass, further preferably 20 to 50 parts by mass, more preferably 25 to 45 parts by mass, and most preferably 30 to 35 parts by mass. In a case where the ratio of the sugar alkanoic acid ester (B) is excessively low, the melt flowability and the melt moldability may be lowered. In contrast, in a case where the ratio is excessively high, the transparency and the mechanical characteristics (in particular, the impact strength) may be lowered.

Since the sugar alkanoic acid ester (B) (in particular, sucrose octaacetate) can improve the melt flowability of the cellulose diacetate (A) (in particular, the melt flowability enough for injection molding), the sugar alkanoic acid ester (B) may also be used as a flow improver of the cellulose diacetate (A) (in particular, a flow improver for improving a melt flowability in injection molding).

Further, since the sugar alkanoic acid ester (B) (in particular, sucrose octaacetate) can improve not only a flowability of the cellulose diacetate (A) but also a strength of the molded article formed with the resin composition, the sugar alkanoic acid ester (B) also acts as a strength improver. Thus, the sugar alkanoic acid ester (B) can also be used as a strength improver of the cellulose diacetate (A).

### Plasticizer

The resin composition of the present invention may further contain a plasticizer in addition to the thermoplastic resin and the sugar ester. The plasticizer may be a conventional plasticizer widely used as a plasticizer for a cellulose acetate.

Examples of the conventional plasticizer may include a hydroxy acid ester such as triethyl citrate, acetyl triethyl citrate, acetyl tributyl citrate, and dibutyl tartrate; a triacylglycerol such as triactin and tripropionin; a polyether such as 2,2-bis(4-polyoxyethylene-oxyphenyl)propane; an aromatic carboxylic acid ester such as dimethyl phthalate (DMP), diethyl phthalate (DEP), dibutyl phthalate (DBP), di-2-methoxyethyl phthalate, diallyl phthalate, ethyl o-benzoylbenzoate, ethyl phthalyl ethyl glycolate (EPEG), and methyl phthalyl ethyl glycolate (MPEG); an aromatic sulfonic acid ester such as o-cresyl p-toluenesulfonate; an aromatic sulfonamide such as N-ethyltoluenesulfonamide; a phosphoric acid ester such as triethyl phosphate (TEP) and triphenyl phosphate (TPP); and a resin oligomer such as a polyester oligomer and a polyamide oligomer.

These conventional plasticizers may be used alone or in combination of two or more. Among them, the hydroxy acid ester such as acetyl tributyl citrate and the polyether such as 2,2-bis(4-polyoxyethylene-oxyphenyl)propane are widely used.

The ratio of the plasticizer relative to 100 parts by mass of the thermoplastic resin may be not more than 50 parts by mass (such as 0.1 to 50 parts by mass) and is preferably not more than 30 parts by mass (such as 1 to 30 parts by mass), further preferably not more than 10 parts by mass, more preferably not more than 5 parts by mass, and most preferably not more than 1 part by mass. In a case where the ratio of the plasticizer is excessively high, the transparency and the mechanical characteristics may be lowered.

Since the resin composition of the present invention can achieve an improved melt flowability by addition of the sugar ester, the resin composition is preferably substantially free from the plasticizer and is most preferably free from the plasticizer. In particular, the resin composition of the present invention is preferably substantially free from the polyester oligomer as the plasticizer and is especially preferably free from the polyester oligomer.

### Other Components

The resin composition of the present invention may further contain a conventional additive, to be added to a cellulose acetate, as another component in addition to the thermoplastic resin and the sugar ester. Examples of the conventional additive may include a stabilizer (such as an antioxidant, an ultraviolet absorber, a light stabilizer, and a heat stabilizer), an acid scavenger, a conductive agent, an antistatic agent, a flame retardant (such as a phosphorus-containing flame retardant, a halogen-containing flame retardant, and an inorganic flame retardant), a flame-retardant auxiliary, an impact modifier, a flow modifier, a leveling agent, an antifoaming agent, a reinforcement material (a filler, e.g., a fibrous reinforcement material such as a glass fiber, a carbon fiber, and a cellulose fiber, a talc, and calcium carbonate), a coloring agent, a lubricant, a release agent, a hue improver, a dispersant, an antibacterial agent, a preservative, a stress reducing agent, and a nucleating agent. These additives may be used alone or in combination of two or more.

The total ratio of another component relative to 100 parts by mass of the thermoplastic resin may be, for example, not more than 100 parts by mass (such as 0.1 to 100 parts by mass) and is preferably not more than 50 parts by mass (such as 1 to 50 parts by mass), further preferably not more than 30 parts by mass, more preferably not more than 10 parts by mass, and most preferably not more than 5 parts by mass.

### Characteristics of Resin Composition

The resin composition of the present invention has a high melt flowability and has a melt flow rate of 2 to 100 g/10 minutes. In a case where the melt flow rate is excessively low, the melt moldability is lowered. In contrast, in a case where the melt flow rate is excessively high, the mechanical characteristics (in particular, the impact strength) is lowered, and the melt moldability and the mechanical characteristics cannot be achieved in a balanced manner. A preferred range of the melt flow rate of the resin composition is 3 to 80 g/10 minutes, 5 to 50 g/10 minutes, 8 to 40 g/10 minutes, 10 to 35 g/10 minutes, and 12 to 30 g/10 minutes in a stepwise manner, and the melt flow rate is most preferably 15 to 20 g/10 minutes.

In the description and the claims of this application, the melt flow rate (MFR or melt flow index MFI) of the resin composition can be measured in accordance with ISO 1133 under the conditions of a retention time of 5 minutes, a temperature of 250° C., and a load of 5 kgf.

The resin composition of the present invention also has excellent mechanical characteristics. The resin composition of the present invention may have a flexural strength of, for example, not less than 100 MPa. The flexural strength is, for example, 100 to 1000 MPa, preferably 130 to 500 MPa, further preferably 135 to 300 MPa, more preferably 140 to 200 MPa, and most preferably 145 to 160 MPa.

The resin composition of the present invention may have a flexural modulus of not less than 1000 MPa. The flexural modulus is, for example, 1000 to 10000 MPa, preferably 2000 to 8000 MPa, further preferably 3000 to 6000 MPa, and more preferably 4000 to 5000 MPa.

In the description and the claims of this application, the flexural strength and the flexural modulus of the resin composition can be measured in accordance with ISO 178.

The resin composition of the present invention may have an IZOD impact strength (notched) of not less than 1 kJ/m². The IZOD impact strength (notched) is, for example, 1 to 30 kJ/m², preferably 2 to 20 kJ/m², further preferably 3 to 10 kJ/m², more preferably 4 to 8 kJ/m², and most preferably 4.5 to 6 kJ/m².

In the description and the claims of this application, the IZOD impact strength of the resin composition can be measured in accordance with ISO 180.

The resin composition of the present invention can be prepared by mixing the thermoplastic resin, the sugar ester, and optionally another component in a conventional method such as dry mixing and melt kneading. The resin composition may be in a pellet form or other forms. For melt kneading, the kneading temperature is, for example, 200 to 280° C., preferably 220 to 260° C., and further preferably 230 to 250° C. The melt kneading can use a conventional means, for example, a twin-screw extrusion kneader.

### Molded Article

The molded article (or the molded product or the molded body) of the present invention can be produced by molding the resin composition in a conventional molding method. Examples of the conventional molding method may include a compression molding method, an injection molding method, an injection compression molding method, an extrusion molding method, a transfer molding method, a blow molding method, a pressure molding method, and a casting molding method. The resin composition of the present invention has an excellent melt flowability. Thus, among these molding methods, a molding method in which a high melt flowability is necessary is preferred, for example, the injection molding method, the injection compression molding method, and the extrusion molding method. The injection molding method is particularly preferred.

In the injection molding method, the cylinder temperature is, for example, 230 to 300° C., preferably 240 to 280° C., further preferably 245 to 275° C., more preferably 250 to 270° C., and most preferably 255 to 265° C. In a case where the cylinder temperature is excessively low, the moldability may be lowered. In contrast, in a case where the cylinder temperature is excessively high, the molded article may have low mechanical characteristics or transparency.

The injection pressure is, for example, 10 to 100 MPa, preferably 20 to 80 MPa, and further preferably 40 to 60 MPa.

The mold temperature is, for example, 100 to 200° C., preferably 110 to 150° C., further preferably 115 to 145° C., more preferably 120 to 140° C., and most preferably 125 to 135° C. An excessively low mold temperature may result in low productivity. In contrast, an excessively high mold temperature may result in low mechanical characteristics or transparency of the molded article.

The molded article of the present invention is not limited to a specific shape. The shape of the molded article can be selected according to the application or use and may include a one-dimensional structure such as a linear shape and a filamentous shape; a two-dimensional structure such as a film shape, a sheet shape, and a plate shape; and a three-dimensional structure such as a block shape, a bar shape, a pipe or tube shape, and a hollow shape. In particular, the resin composition of the present invention can produce a molded article by injection molding with a high productivity. Thus, the resin composition can produce a three-dimensional structure with a high productivity, although a conventional cellulose diacetate is difficult to mold or shape into a three-dimensional structure.

### EXAMPLES

The following examples are intended to describe this disclosure in further detail and should by no means be interpreted as defining the scope of the disclosure. Various evaluation methods, and abbreviations and details of raw materials are shown below.

### MFR

In accordance with ISO 1133, an MER was measured under the conditions of a retention time of 5 minutes, a temperature of 250° C., and a test load of 5 kgf.

### Flexural Strength and Flexural Modulus

A flexural strength and a flexural modulus were measured in accordance with ISO 178.

### IZOD Impact Strength (Notched)

An IZOD impact strength (notched) was measured in accordance with ISO 180.

### Raw Material

### Cellulose Diacetate

Cellulose diacetate (DAC): “Cellulose acetate L-30” manufactured by Daicel Corporation

### Esterified Sugar

Sucrose octaacetate: manufactured by Tokyo Chemical Industry Co., Ltd.

### Comparative Compound

Sucrose: manufactured by Tokyo Chemical Industry Co., Ltd.
Sucrose benzoate: manufactured by Tokyo Chemical Industry Co., Ltd.
Sucrose fatty acid ester: manufactured by Tokyo Chemical Industry Co., Ltd. (fatty acid composition: palmitic acid 75.0% or more)
2,2-Bis(4-polyoxyethylene-oxyphenyl)propane (BA-10): “BA-10 Glycol” manufactured by NIPPON NYUKAZAI CO., LTD.
Acetyl tributyl citrate (ATBC): manufactured by Tokyo Chemical Industry Co., Ltd.

### Examples 1 to 5 and Comparative Examples 1 to 5

For each Example, components each having a mass ratio shown in Table 1 were kneaded at a temperature of 240° C., a screw rotation speed of 200 rpm, and a discharge rate of about 500 g/h using a twin-screw extruder (“Process 11” manufactured by Thermo Fisher Scientific Inc.) to prepare a resin composition in a pellet form. A kneaded product which stably achieved formation into a strand shape and cutting was graded as “Pass” for pelletization, and a kneaded product which did not achieve the above-mentioned formation and cutting due to heat deterioration was graded as “Fail” for pelletization. Moreover, a composition which was visually transparent was graded as “Transparent”, a composition which was visually opaque was graded as “Opaque”. The resulting resin composition was injection-molded using a piston injection molding machine (“HAAKE MiniJet Pro” manufactured by Thermo Fisher Scientific Inc.) under the conditions of a cylinder temperature of 260° C. and a mold temperature of 130° C. to give a strip specimen. Moreover, the resulting resin composition was evaluated for the MFR. The resulting specimen was evaluated for the 10 flexural strength, the flexural modulus, and the IZOD impact strength. Table 1 shows the adding ratio and the evaluation results.

TABLE 1

| | | | Examples | | | | |
|---|---|---|---|---|---|---|---|
| | Items | Unit | 1 | 2 | 3 | 4 | 5 |
| Composition | DAC | parts by | 85 | 80 | 75 | 70 | 65 |
| | | mass | | | | | |
| | Sucrose | parts by | 15 | 20 | 25 | 30 | 35 |
| | octaacetate | mass | | | | | |
| | Sucrose benzoate | parts by | — | — | — | — | — |
| | | mass | | | | | |
| | Sucrose | parts by | — | — | — | — | — |
| | | mass | | | | | |
| | Sucrose fatty acid | parts by | — | — | — | — | — |
| | ester | mass | | | | | |
| | BA-10 | parts by | — | — | — | — | — |
| | | mass | | | | | |
| | ATBC | parts by | — | — | — | — | — |
| | | mass | | | | | |
| Kneading | Pelletization | — | Pass | Pass | Pass | Pass | Pass |
| | Transparency | — | Transparent | Transparent | Transparent | Transparent | Transparent |
| Physical | MFR | g/10 min | 4.9 | 8.8 | 18.7 | 38.0 | 71.1 |
| properties | Flexural strength | MPa | 147.6 | 146.1 | 146.3 | 147.2 | 145.7 |
| | Flexural modulus | MPa | 4455 | 4169 | 4580 | 4716 | 4841 |
| | IZOD impact | kJ/m² | 5.18 | 5.59 | 4.96 | 3.24 | 2.69 |
| | strength | | | | | | |

| | | | Comparative Examples | | | | |
|---|---|---|---|---|---|---|---|
| | Items | Unit | 1 | 2 | 3 | 4 | 5 |
| Composition | DAC | parts by | 75 | 75 | 75 | 75 | 75 |
| | | mass | | | | | |
| | Sucrose | parts by | — | — | — | — | — |
| | octaacetate | mass | | | | | |
| | Sucrose benzoate | parts by | 25 | — | — | — | — |
| | | mass | | | | | |
| | Sucrose | parts by | — | 25 | — | — | — |
| | | mass | | | | | |
| | Sucrose fatty acid | parts by | — | — | 25 | — | — |
| | ester | mass | | | | | |
| | BA-10 | parts by | — | — | — | 25 | — |
| | | mass | | | | | |
| | ATBC | parts by | — | — | — | — | 25 |
| | | mass | | | | | |
| Kneading | Pelletization | — | Pass | Fail | Fail | Pass | Pass |
| | Transparency | — | Opaque | Opaque | Opaque | Opaque | Opaque |
| Physical | MFR | g/10 min | — | — | — | — | — |
| properties | Flexural strength | MPa | — | — | — | 81.9 | 87.9 |
| | Flexural modulus | MPa | — | — | — | 2519 | 2670 |
| | IZOD impact | kJ/m² | — | — | — | — | — |
| | strength | | | | | | |

As apparent from the results shown in Table 1, in Examples, the molded articles with excellent transparency and mechanical characteristics were obtained by injection molding.

### INDUSTRIAL APPLICABILITY

The resin composition of the present invention has excellent transparency, biodegradability, and mechanical characteristics and thus can be used for resin molded articles in various fields [for example, an automotive part, an electrical/electronic part, a building material or member (such as a wall material), a civil engineering material or member, an agricultural material or member, a packaging material or member (such as a container and a cushioning material), and a daily life material or member (such as a daily use item)]. In particular, the resin composition has an excellent mechanical strength and is thus suitable for the molded article including the automotive part and the electrical/electronic part. Moreover, since the resin composition has an excellent transparency, the resin composition can suitably be used for the packaging material or member (such as a transparent container) or a molded article for optical use (an optical molded article or an optical member).

1. A melt-molding resin composition comprising a thermoplastic resin and a sugar ester, wherein
the thermoplastic resin is a cellulose diacetate (A), and
the sugar ester comprises a sugar alkanoic acid ester (B) which is an esterified product of at least one member selected from the group consisting of a monosaccharide, an oligosaccharide, and a sugar alcohol with a C₂₋₆alkanoic acid.

2. The resin composition according to claim 1, wherein the sugar alkanoic acid ester (B) is an ester of a monosaccharide or a disaccharide with a C₂₋₄alkanoic acid.

3. The resin composition according to claim 1, wherein the sugar alkanoic acid ester (B) is a completely esterified product of a disaccharide with a C₂₋₃alkanoic acid.

4. The resin composition according to claim 1, wherein the sugar alkanoic acid ester (B) is sucrose octaacetate.

5. The resin composition according to claim 4, wherein a proportion of the sucrose octaacetate is not less than 90% by mass in the sugar ester.

6. The resin composition according to claim 1, wherein a ratio of the sugar alkanoic acid ester (B) is 10 to 65 parts by mass relative to 100 parts by mass of the cellulose diacetate (A).

7. The resin composition according to claim 1, which is an injection-molding resin composition.

8. A molded article comprising a resin composition recited in claim 1.

9. The molded article according to claim 8, which is a part or material or member selected from an automotive part, an electrical/electronic part, a building material or member, a civil engineering material or member, an agricultural material or member, a packaging material or member, a daily life material or member, and an optical member.

10. A method for producing a molded article, the method comprising melt-molding a resin composition recited in claim 1.

11. The method according to claim 10, wherein the resin composition is injection-molded to produce the molded article.

12. A strength improver which improves a strength of a cellulose diacetate (A), the strength improver comprising a sugar alkanoic acid ester (B) which is an esterified product of at least one member selected from the group consisting of a monosaccharide, an oligosaccharide, and a sugar alcohol with a C₂₋₆alkanoic acid.

13. A flow improver which improves a melt flowability of a cellulose diacetate (A), the flow improver comprising a sugar alkanoic acid ester (B) which is an esterified product of at least one member selected from the group consisting of a monosaccharide, an oligosaccharide, and a sugar alcohol with a C₂₋₆alkanoic acid.

14. A method for improving a melt flowability and/or a strength of a cellulose diacetate (A), the method comprising mixing a sugar alkanoic acid ester (B) with the cellulose diacetate (A), wherein the sugar alkanoic acid ester (B) is an esterified product of at least one member selected from the group consisting of a monosaccharide, an oligosaccharide, and a sugar alcohol with a C₂₋₆alkanoic acid.
